(19) United States
(12) Patent Application Publication
(10) Pub. No.: US 2025/0323564 A1
(43) Pub. Date: Oct. 16, 2025

(54) METHODS AND SYSTEMS FOR VARYING THE FREQUENCY OF A POWER CONVERTER BASED ON AN EXTERNAL CLOCK

(71) Applicant: Cirrus Logic International Semiconductor Ltd., Edinburgh (GB)

(72) Inventors: Jason W. LAWRENCE, Austin, TX (US); Graeme G. MACKAY, Austin, TX (US)

(73) Assignee: Cirrus Logic International Semiconductor Ltd., Edinburgh (GB)

(21) Appl. No.: 18/969,919

(22) Filed: Dec. 5, 2024

Related U.S. Application Data
(60) Provisional application No. 63/633,094, filed on Apr. 12, 2024.

(51) Int. Cl. H02M 1/00

(52) U.S. Cl. CPC H02M 1/0029; H02M 1/0009

(57) ABSTRACT

A method for varying a variable switching frequency of a power converter based on a variable external clock may include generating, with a queue, an internal clock signal with a same sequence of periods as the variable external clock and with a fixed delay from the variable external clock. The method may also include determining a period of the internal clock signal at a start of each cycle of the internal clock signal. The method may further include for each cycle of the internal clock signal, scaling a slope of a carrier signal of a modulator configured to generate one or more switching signals of the power converter.

### RELATED APPLICATION

The present disclosure claims priority to U.S. Provisional Patent Application Ser. No. 63/633,094, filed Apr. 12, 2024, which is incorporated by reference herein in its entirety.

### FIELD OF DISCLOSURE

The present disclosure relates in general to circuits for electronic devices, including without limitation personal audio devices such as wireless telephones and media players, and more specifically, closed-loop control of power converters, including varying the frequency of a power converter based on an external clock.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

In some applications, it may be desirable to vary a switching frequency of the control signals used to control a power converter. For example, varying the switching frequency of a power converter may provide a spread spectrum system. As another example, varying the switching frequency of a power converter may allow avoidance of operation in certain frequency ranges, so as to provide an electromagnetic interference mask for handling aggressor signals in internal circuitry.

### SUMMARY

In accordance with the teachings of the present disclosure, one or more disadvantages and problems associated with operation of power converters may be reduced or eliminated.

In accordance with embodiments of the present disclosure, a method for varying a variable switching frequency of a power converter based on a variable external clock may include generating, with a queue, an internal clock signal with a same sequence of periods as the variable external clock and with a fixed delay from the variable external clock. The method may also include determining a period of the internal clock signal at a start of each cycle of the internal clock signal. The method may further include for each cycle of the internal clock signal, scaling a slope of a carrier signal of a modulator configured to generate one or more switching signals of the power converter.

In accordance with these and other embodiments of the present disclosure, a system for varying a variable switching frequency of a power converter based on a variable external clock may include a queue configured to generate an internal clock signal with a same sequence of periods as the variable external clock and with a fixed delay from the variable external clock and determine a period of the internal clock signal at a start of each cycle of the internal clock signal. The system may also include a modulator configured to, for each cycle of the internal clock signal, scale a slope of a carrier signal of a modulator configured to generate one or more switching signals of the power converter.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of any example clock generation system, in accordance with embodiments of the present disclosure;

FIG. 2 illustrates a block diagram of selected components of an example power converter system, in accordance with embodiments of the present disclosure;

FIG. 3 illustrates example timing diagrams for an external clock, a clock pulse signal generated from the external clock, and modulator carrier signals modified as a function of the period of the clock pulse signal, in accordance with embodiments of the present disclosure;

FIG. 4 illustrates selected components of an ADC and an example sample rate converter, in accordance with embodiments of the present disclosure;

FIG. 5A illustrates selected components of an example cycle average estimator of the sample rate converter of FIG. 4, in accordance with embodiments of the present disclosure; and

FIG. 5B illustrates selected components of an example cycle average estimator of the sample rate converter of FIG. 4, in accordance with embodiments of the present disclosure.

### DETAILED DESCRIPTION

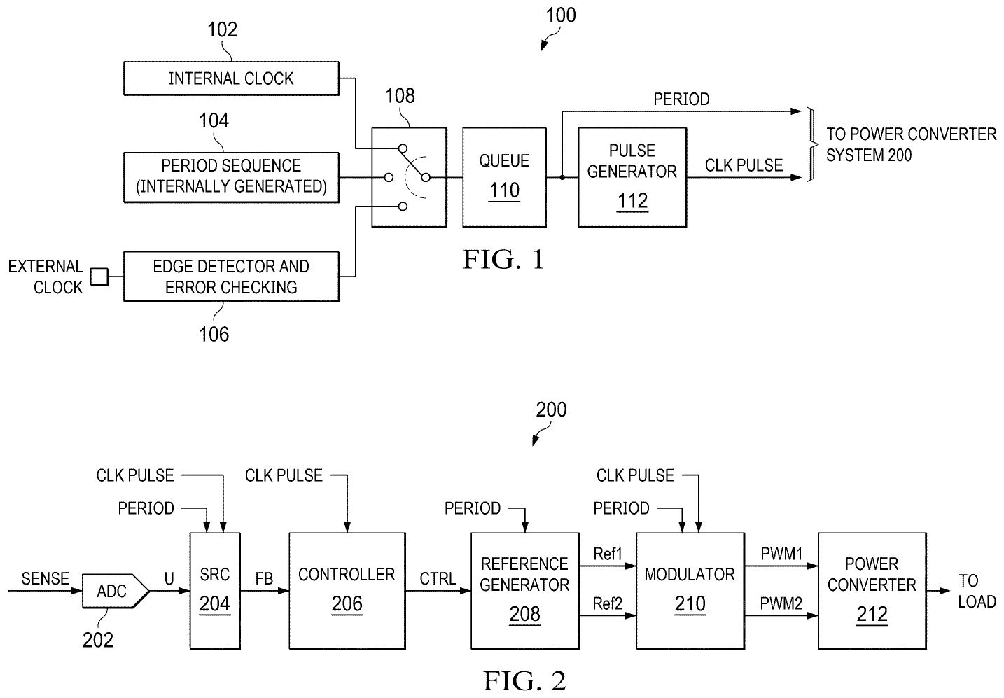

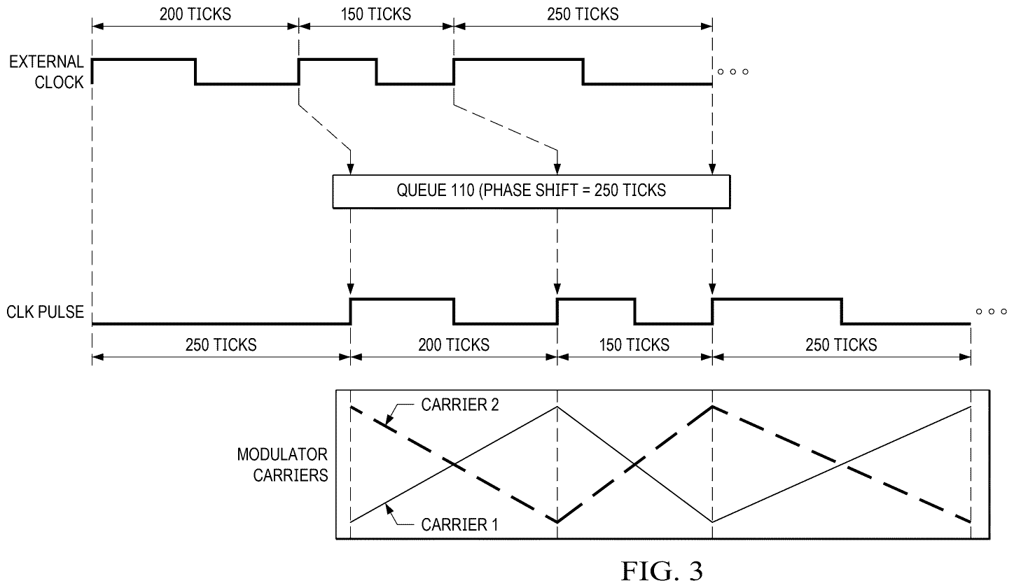

FIG. 1 illustrates a block diagram of selected components of any example clock generation system 100, in accordance with embodiments of the present disclosure. As described in greater detail below, clock generation system 100 may be used to provide a clock pulse signal and a period signal defining a period of the clock pulse signal to a power converter system, such as the power converter system described with reference to FIG. 2. As shown in FIG. 1, clock generation system 100 may include an internal clock 102, an internally generated period sequence 104, and an edge detection and error checking subsystem 106 configured to receive an external clock signal, a multiplexer 108, a queue 110, and a pulse generator 112.

Internal clock 102 may comprise any suitable system, device, or apparatus (e.g., a phase-locked loop, a delay-locked loop, a crystal oscillator, etc.) configured to generate an internal clock signal within an electronic system.

Period sequence 104 may comprise any suitable system, device, or apparatus configured to generate any suitable sequence of switching frequencies or periods (e.g., internally generated by the integrated circuit used to implement clock generation system 100). For example, for spread-spectrum frequency, period sequence 104 may generate a random or pseudo-random sequence, or it may generate a signal with a repeating pattern (triangle modulation is common).

Edge detection and error checking subsystem 106 may comprise any suitable system, device, or apparatus configured to receive an external clock signal and perform edge detection and error checking on such external clock signal, and generate a processed external clock signal which is a function of the received external clock signal.

Multiplexer 108 may comprise any suitable system, device, or apparatus configured to select among internal clock 102, period sequence 104, and the processed external clock signal generated by edge detection and error checking subsystem 106 and output the selected signal.

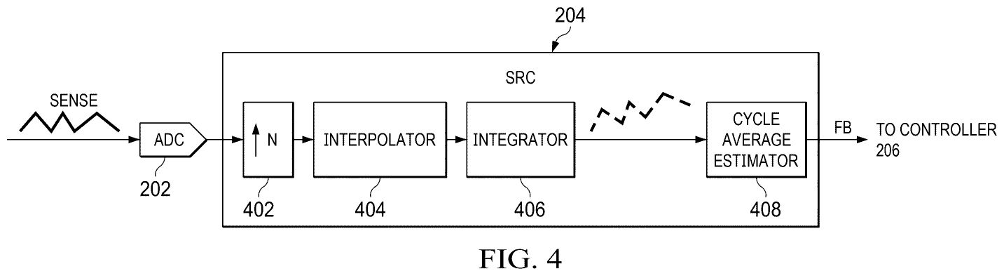

Queue 110 may comprise any suitable system, device, or apparatus configured to receive the signal selected by multiplexer 108 and output a period signal PERIOD indicative of a period of a variable clock, as described in more detail with reference to FIG. 3 and elsewhere below.

Pulse generator 112 may comprise any suitable system, device, or apparatus configured to receive period signal PERIOD and generate a clock pulse signal CLK PULSE having pulses corresponding to period signal PERIOD.

FIG. 2 illustrates a block diagram of selected components of an example power converter system 200, in accordance with embodiments of the present disclosure. As shown in FIG. 2, power converter system 200 may include an analog-to-digital converter (ADC) 202, a sample rate converter (SRC) 204, a controller 206, a reference generator 208, a modulator 210, and a power converter 212.

ADC 202 may comprise any suitable system, device, or apparatus configured to receive an analog sense signal SENSE indicative of a measured physical quantity associated with power converter 212 (e.g., a voltage or a current associated with power converter 212) and generate a digital signal U equivalent to analog sense signal SENSE.

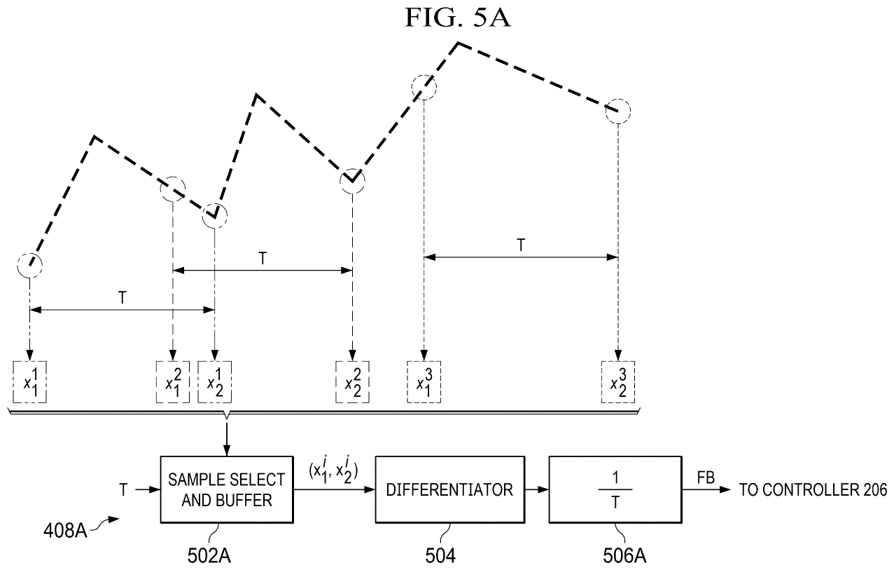

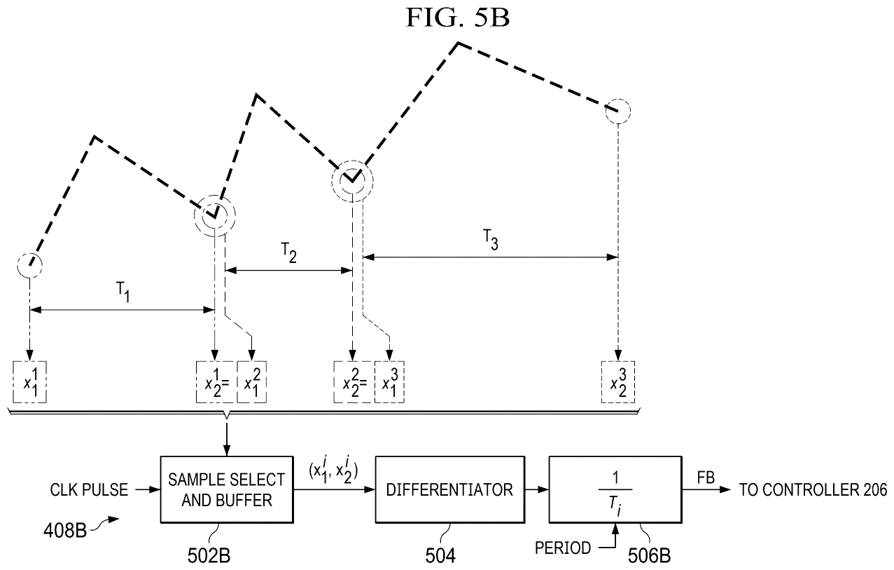

SRC 204 may receive digital signal U from ADC 202 and based on digital signal U, period signal PERIOD, and clock pulse signal CLK PULSE, generate a control feedback signal FB. As described in more detail with reference to FIGS. 4, 5A, and 5B, and elsewhere below, measurements of a cycle average of output of controller 206 may be provided by SRC 204 at the variable switching frequency based on a measured period (e.g., period signal PERIOD) and clock pulse signal CLK PULSE.

Controller 206 may comprise any system, device, or apparatus configured to implement a control loop to control power converter 212 at the variable switching frequency in order to regulate analog sense signal SENSE to track a target value or set point. For example, based on an error between the target value and analog sense signal SENSE, controller 206 may generate a control signal CTRL. As shown in FIG. 2, controller 206 may receive clock pulse signal CLK PULSE, and controller 206 may perform control through triggering control calculations by using clock pulse signal CLK PULSE.

Reference generator 208 may comprise any system, device, or apparatus configured to, based on control signal CTRL, generate two reference signals REF1 and REF2 for modulator 210. For example, control signal CTRL may indicate whether reference generator 208 should increase or decrease either or both of reference signals REF1 and REF2 in order to regulate analog sense signal SENSE by power converter 212.

Modulator 210 may comprise any suitable system, device, or apparatus configured to receive reference signals REF1 and REF2, period signal PERIOD, clock pulse signal CLK PULSE, and based thereon generate switching signals PWM1 and PWM2 for controlling switching of switches integral to power converter 212. For example, modulator 210 may generate switching signals PWM1 and PWM2 by respectively comparing reference signals REF1 and REF2 against one or more triangle wave carrier signals. In some embodiments, modulator 210 may comprise a pulse-width modulator.

Power converter 212 may comprise any suitable system, device, or apparatus configured to drive an output signal based on switching signals PWM1 and PWM2 provided from modulator 210. In some embodiments, power converter 212 may comprise an inductive-and/or capacitive-based power converter. Power converter 212 may drive any suitable electronic load.

FIG. 3 illustrates example timing diagrams for a processed external clock signal, clock pulse signal CLK PULSE generated from the external clock signal, and carrier signals CARRIER1 and CARRIER2 for modulator 210 modified as a function of the period of clock pulse signal CLK PULSE, in accordance with embodiments of the present disclosure. As mentioned previously, queue 110 may measure the period of the processed external clock signal when the processed external clock signal is selected by multiplexer 108. Thus, in the example of FIG. 3, queue 110 may measure a period (and generate a resulting period signal PERIOD) of 200 ticks for the first cycle, 150 ticks in the second cycle, and 250 ticks for the third cycle, and store such information. Pulse generator 112 may sequentially receive successive values of period signal PERIOD from queue 110 and generate clock pulse signal CLK PULSE based on the values of period signal PERIOD. Clock pulse signal CLK PULSE may require a phase shift relative to the processed external clock signal that is at least as long as the largest possible period of the processed external clock signal (e.g., 250 ticks in the example of FIG. 3). Accordingly, clock pulse signal CLK PULSE may be identical to the processed external clock signal, but with a fixed delay or shift. This may also enable the measured period to be known at the start of each cycle of clock pulse signal CLK PULSE.

Modulator 210 may, based on the period signal PERIOD, generate carrier signals CARRIER1 and CARRIER2 to have slopes as a function of the period signal PERIOD. For example, modulator 210 may increase the magnitude of the slopes of carrier signals CARRIER1 and CARRIER2 in response to decreasing periods of clock pulse signal CLK PULSE and may decrease the magnitude of the slopes of carrier signals CARRIER1 and CARRIER2 in response to increasing periods of clock pulse signal CLK PULSE. Cycle to cycle adjustments made by modulator 210 to carrier signals CARRIER1 and CARRIER2 may be performed such that carrier signals CARRIER1 and CARRIER2 remain synchronous with clock pulse signal CLK PULSE. As a result, modulator 210 may generate switching signals PWM1 and PWM2 for power converter 212 at the same frequency as clock pulse signal CLK PULSE and the processed external clock signal.

FIG. 4 illustrates selected components of ADC 202 and example SRC 204, in accordance with embodiments of the present disclosure. As shown in FIG. 4, SRC 204 may include an upsampler 402, an interpolator 404, an integrator 406, and a cycle average estimator 408.

Upsampler 402 may include any system, device, or apparatus configured to perform upsampling or expansion of the digital signal output by ADC 202. For example, upsampling performed on a sequence of samples of the digital signal output by ADC 202, to produce an approximation of the sequence that would have been obtained by sampling the digital signal output by ADC 202 at a higher rate. Interpolator 404 may include any system, device, or apparatus configured to perform interpolation, to select data points for the upsampled version of the digital signal output by ADC 202. Integrator 406 may include any system, device, or apparatus configured to perform mathematical integration on the upsampled and interpolated digital signal.

Cycle average estimator 408 may include any system, device, or apparatus configured to receive the integrated digital signal, estimate the cycle average of the integrated digital signal, and generate the estimated cycle average as control feedback signal FB to controller 206. FIGS. 5A and 5B depict example implementations of cycle average estimator 408.

FIG. 5A illustrates selected components of example cycle average estimator 408A, in accordance with embodiments of the present disclosure. Cycle average estimator 408A may be used to implement cycle average estimator 408 of FIG. 4. As shown in FIG. 5A, cycle average estimator 408A may include a sample select and buffer block 502A, a differentiator 504, and a fixed gain block 506A. Sample select and buffer block 502A may receive a fixed period signal T (which may be equal to an average period of the external clock signal) and identify samples

$$( e . g . , {x}_{1}^{i} = {x}_{1}^{1} , {x}_{1}^{2} , … , {x}_{1}^{N} ; {x}_{2}^{i} = {x}_{2}^{1} , {x}_{2}^{2} , … , {x}_{2}^{N} )$$

of the integrated digital signal in accordance with the fixed period signal T. Differentiator 504 may calculate a difference between pairs of samples

$${x}_{1}^{i} and {x}_{2}^{i} .$$

For each difference calculation by differentiator 504, fixed gain block 506A may apply a fixed gain 1/T to the difference to generate control feedback signal FB to controller 206.

FIG. 5B illustrates selected components of example cycle average estimator 408B, in accordance with embodiments of the present disclosure. Cycle average estimator 408B may be used to implement cycle average estimator 408 of FIG. 4. As shown in FIG. 5B, cycle average estimator 408B may include a sample select and buffer block 502B, a differentiator 504, and a variable gain block 506B. Sample select and buffer block 502B may receive clock pulse signal CLK PULSE and identify samples

$$( e . g . , {x}_{1}^{i} = {x}_{1}^{1} , {x}_{1}^{2} , … , {x}_{1}^{N} ; {x}_{2}^{i} = {x}_{2}^{1} , {x}_{2}^{2} , … , {x}_{2}^{N} )$$

of the integrated digital signal at each rising edge of clock pulse signal CLK PULSE. Accordingly, unlike cycle average estimator 408A, the period between selected samples

$${x}_{1}^{i} and {x}_{2}^{i}$$

may vary. Differentiator 504 may calculate a difference between pairs of samples

$${x}_{1}^{i} and {x}_{2}^{i} .$$

For each difference calculation by differentiator 504, variable gain block 506B may apply a variable gain 1/Tᵢ (that varies with period signal PERIOD) to the difference to generate control feedback signal FB to controller 206.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A method for varying a variable switching frequency of a power converter based on a variable external clock, the method comprising:
generating, with a queue, an internal clock signal with a same sequence of periods as the variable external clock and with a fixed delay from the variable external clock;
determining a period of the internal clock signal at a start of each cycle of the internal clock signal; and
for each cycle of the internal clock signal, scaling a slope of a carrier signal of a modulator configured to generate one or more switching signals of the power converter.

2. The method of claim 1, further comprising:
controlling an output of the power converter at the variable switching frequency by triggering control calculations with the internal clock signal; and
generating measurement of a cycle average of outputs of the controller at the variable switching frequency based on the period and the internal clock signal.

3. The method of claim 2, wherein generating measurement of a cycle average of outputs of the controller comprises:
identifying samples of the outputs of the controller in accordance with a fixed period; and
applying a fixed gain to differences between successive samples based on the fixed period to generate the cycle average.

4. The method of claim 2, wherein generating measurement of a cycle average of outputs of the controller comprises:
identifying samples of the outputs of the controller in accordance with a variable period; and
applying a variable gain to differences between successive samples based on the variable period to generate the cycle average.

5. A system for varying a variable switching frequency of a power converter based on a variable external clock, the system comprising:
a queue configured to:
generate an internal clock signal with a same sequence of periods as the variable external clock and with a fixed delay from the variable external clock; and
determine a period of the internal clock signal at a start of each cycle of the internal clock signal; and
a modulator configured to, for each cycle of the internal clock signal, scale a slope of a carrier signal of a modulator configured to generate one or more switching signals of the power converter.

6. The system of claim 5, further comprising a sample rate converter configured to:
control an output of the power converter at the variable switching frequency by triggering control calculations with the internal clock signal; and
generate measurement of a cycle average of outputs of the controller at the variable switching frequency based on the period and the internal clock signal.

7. The system of claim 6, wherein generating measurement of a cycle average of outputs of the controller comprises:
identifying samples of the outputs of the controller in accordance with a fixed period; and
applying a fixed gain to differences between successive samples based on the fixed period to generate the cycle average.

8. The system of claim 6, wherein generating measurement of a cycle average of outputs of the controller comprises:
identifying samples of the outputs of the controller in accordance with a variable period; and
applying a variable gain to differences between successive samples based on the variable period to generate the cycle average.
